(19) United States
(12) Patent Application Publication
(10) Pub. No.: US 2008/0020096 A1
(43) Pub. Date: Jan. 24, 2008

(54) System for Adding Consumable Enhancing Additives to Drinking Water

(76) Inventors: Bradley J. Blum, Roanoke, VA (US); Marcus T. Peverill, Fraser, CO (US); Phyllis Elizabeth Hickam, Galax, VA (US); Mary L. Hamrick, Gaffney, SC (US); Michael B. Montag, Fairfax, VA (US)

Correspondence Address: THE CLOROX COMPANY, P.O. BOX 24305, OAKLAND, CA, 94623-1305, US

(21) Appl. No.: 11/844,211

(22) Filed: Aug. 23, 2007

Related U.S. Application Data
(63) Continuation of application No. 10/631,774, filed on Aug. 1, 2003.

(51) Int. Cl. A23L 2/52; B01D 35/00

(52) U.S. Cl. 426/66; 210/198.1; 210/85; 210/97

(57) ABSTRACT

Embodiments of the present invention relate to a system for treating drinking water to enhance it with consumable additives such as vitamins and flavor. The system may be connectable to a source of drinking water such as home faucet, and operable to selectably introduce additives into the drinking water.

This application claims the benefit under 35 USC section 119(e) of U.S. provisional application No. 60/400,127, filed Aug. 2, 2002, the entirety of which is incorporated herein by reference.

### BACKGROUND OF THE INVENTION

Studies have shown that many people are not receiving 100% of their RDA (recommended daily allowance) of vitamins and nutrients. A shortage of nutrients and vitamins in the diet may lead to health problems.

One way in which the marketplace has attempted to meet the need for better nutrition is through “enhanced” bottled water. Typically given such labels as “fitness water” and “vitamin water,” enhanced bottled water products may be enhanced by the addition of common vitamins, minerals and nutrients; flavors may also be added to increase appeal to consumers.

The inconvenience and cost of obtaining enhanced bottled water products on a regular basis, however, may discourage consumers from pursuing this potential source of better nutrition. Accordingly, a more convenient and cost-effective approach to providing better nutrition to the public is called for.

### BRIEF DESCRIPTION OF THE DRAWINGS

FIG. 1 shows an example of a system for selectably adding consumable enhancing additives to drinking water according to embodiments of the present invention;

FIG. 2 shows an example of a cartridge for containing and releasing consumable enhancing additives to water according to embodiments of the invention;

FIG. 2A shows a partial sectional view of the cartridge in FIG. 2;

FIG. 3 shows an example of a pill for encapsulating consumable enhancing additives according to embodiments;

FIG. 3A shows a sectional view of the pill in FIG. 3;

FIG. 4 shows an example of a dispensing mechanism according to embodiments;

FIG. 5 shows an example of a dispensing mechanism according to alternative embodiments; and

FIG. 5A shows an example of an injector button for dispensing a selected additive according to embodiments.

### DETAILED DESCRIPTION

Embodiments of the present invention relate to a cost-effective and convenient system for providing better nutrition through enhanced drinking water. As described in more detail in the following, the system may be configured to attach to a drinking water source such as a home faucet, and to selectably treat water from the source with consumable enhancing additives such as nutrients vitamins and flavors. Thus, the system may make better nutrition conveniently available in the home as easily as, for example, turning on a tap at the kitchen sink.

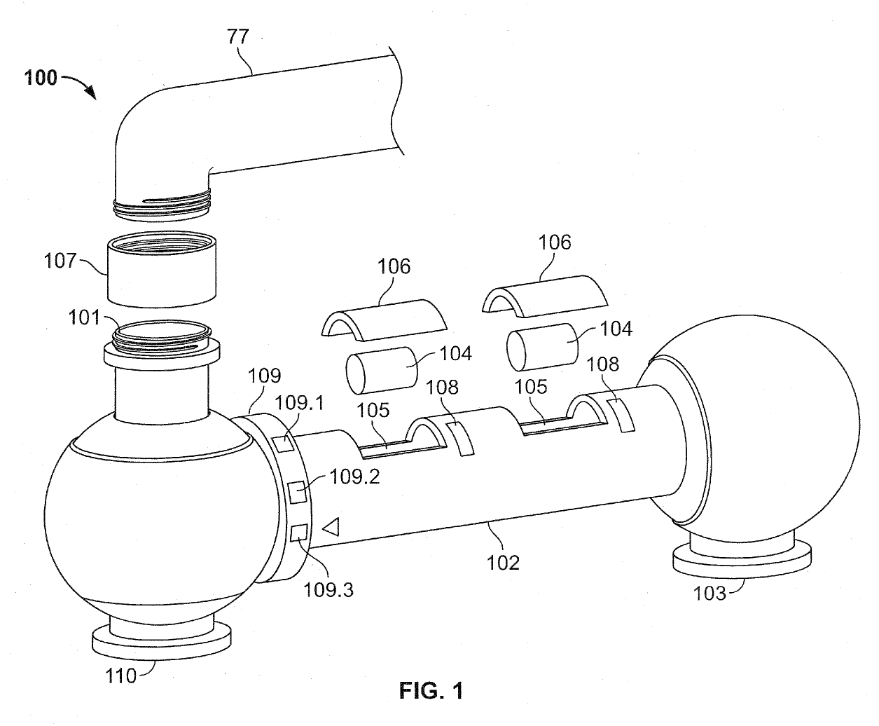

FIG. 1 shows an example of a system for enhancing the content of drinking water according to embodiments of the present invention. The system 100 may comprise an inlet 101 that can be sealably connected to a source of drinking water, such as a home faucet 77. The system may further comprise a portion 102 for enhancing the content of drinking water from the source, coupled between the inlet 101 and an outlet 103 for the enhanced drinking water. The enhancing portion 102 could include a channel or conduit for water to pass from the inlet 101 to the outlet 103. The system may further comprise a water filter 107 disposed, for example, between the source 77 and the inlet 101. In such an embodiment, the filter could be implemented in any stand-alone commercially-available filter. Alternatively, the filter could be associated with the enhancing portion 102; for example, the filter could be disposed in the enhancing portion ahead of a dispensing mechanism for selectably dispensing consumable enhancing additives. An outlet 110 could be provided for untreated water directly from the source 77.

As noted, the enhancing portion 102 may comprise a dispensing mechanism for selectably dispensing consumable enhancing additives, such as nutrients, vitamins and flavors, into a flow of water from the source 77. In embodiments, the dispensing mechanism may comprise replaceable cartridges 104 containing consumable enhancing additives. The portion 102 may comprise openings or slots 105 configured to receive the cartridges. The slots 105 may have corresponding covers or lids 106 able to substantially seal the slots closed so as to prevent water leakage. The cartridges may be configured to release a consumable enhancing additive into a flow of water in the enhancing portion 102. In the example of FIG. 1, a first cartridge could contain a nutrient(s) and/or vitamin(s), while a second cartridge contained a flavor. However, the system is not limited to two cartridges.

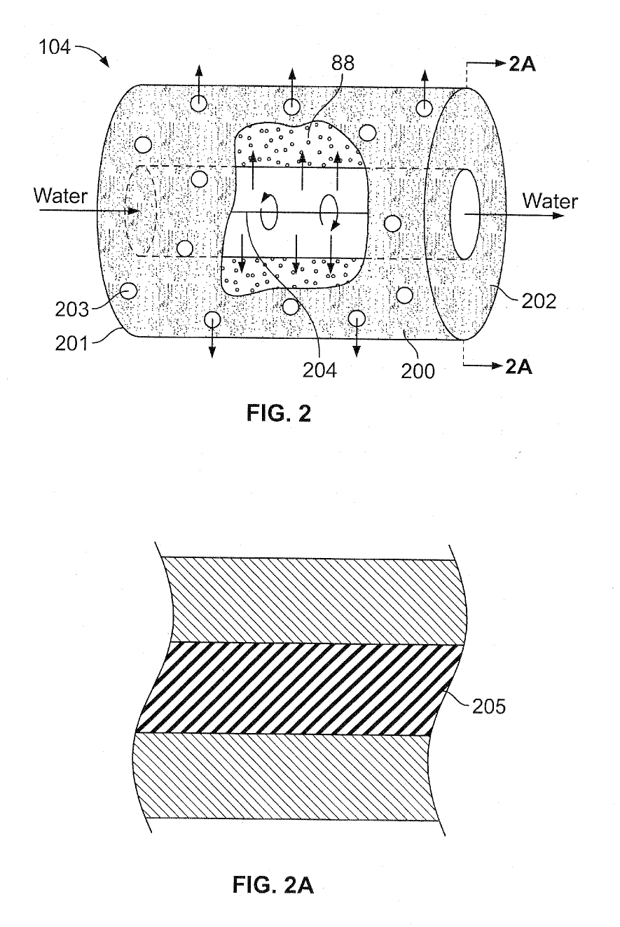

Referring to FIG. 2, a cartridge 104 may, for example, according to embodiments, be formed as a cylinder having walls 200 connecting an inlet end 201 and an outlet end 202. There could be a plurality of openings or pores 203 in the walls, to allow consumable enhancing additives contained within the cylinder to be released into a flow of drinking water. A channel 204 for the passage of water may be formed in the cylinder, and extend between the inlet end 201 and the outlet end 202.

The cylinder cartridge 104 may contain consumable enhancing additives that have been encapsulated or micro-encapsulated within pellets or pills 88. These pills 88 could be released into a flow of water through the enhancing portion 102 via the openings 203 in the cylinder walls. To this end, the channel 204 through the cylinder may comprise a spiral structure, such as spiral grooves or fins 205, as shown in a partial cross-sectional view in FIG. 2A, to facilitate spinning of the cylinder in the water flow, thereby causing the pill 88 to be propelled outward through the openings 203 by centrifugal force

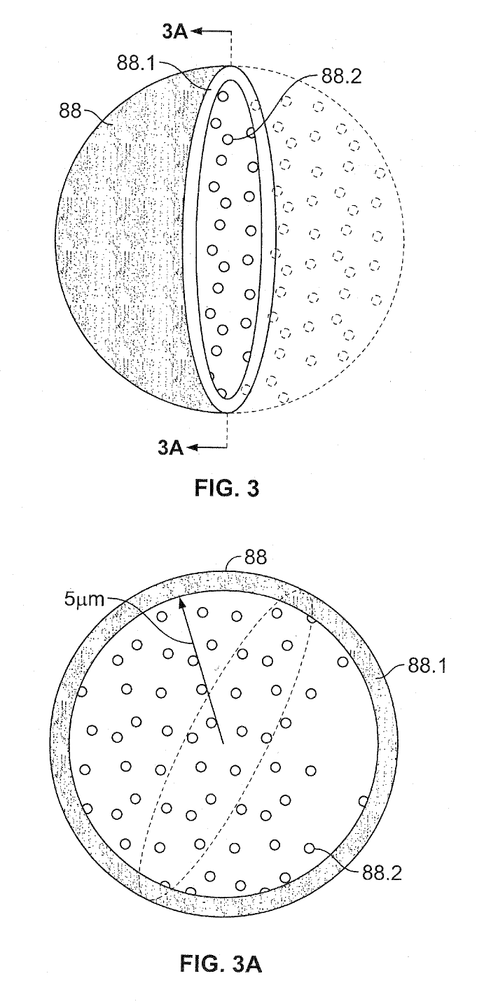

Referring to FIG. 3, according to embodiments, the pills 88 may comprise a water-soluble coating or shell 88.1 surrounding a consumable enhancing additive 88.2. The shell 88.1 could, for example, include an edible polymer such as hydrolyzed starch, acrylic acid, or cellulose. The additive 88.2 could be any of a nutrient, a vitamin, a flavor, or other enhancing substance. Outside the cylinder, the pills may dissolve in the water flow to introduce the consumable enhancing additive into the water. As shown in the cross-sectional view of FIG. 3A, in embodiments the pills could have a radius on the order of microns (0.000001 meters). For example, the radius could be five microns. Accordingly, in embodiments, the openings or pores 203 in the cylinder wall could have a radius about twice the radius of the pills or greater; that is, about 10 microns or greater. However, the pills 88 and pores 203 are not limited to the foregoing dimensions, and could be larger or smaller.

In alternative embodiments, a cartridge may simply be a mass of compressed additive that slowly dissolves over time as water passes over, through or around the cartridge.

Returning to FIG. 1, the system 100 could include indicators 108 for indicating when the cartridges 104 need to be replaced. The indicators could, for example, be coupled to a monitoring mechanism such as a microchip containing a programmable clock. The indicators could be implemented as, for example, light-emitting diodes or LCD (liquid crystal display) readouts, and the clock could be programmed to cause the indicators to, for example, light up or flash after a predetermined period of time had passed since installing a new cartridge, for example, a month. A user could then replace this cartridge with a fresh one and reset the clock. An indicator could also be triggered by a flow meter configured to monitor the amount of water flowing through a corresponding cartridge. In such an arrangement, the flow meter could be coupled to the indicator and send a signal to the indicator to cause it to light up or flash after a pre-determined volume of water had flowed through the corresponding cartridge.

The system 100 could further comprise a switching mechanism 109. The switching mechanism could operate to cause a flow of water into the inlet 101 to selectably be treated by only filtering, bypassing the cartridges 104, and thereby producing water, for example at the outlet 110, that may have only been filtered but not otherwise enhanced. On the other hand, the switching mechanism could operate to cause a flow of water into the inlet 101 to selectably be treated by both filtering and by the cartridges 104, or to select only one cartridge for enhancement of the water. For example, one cartridge could contain nutrients or vitamins, while another contained a flavor. As shown in FIG. 1, the switching mechanism 109 could comprise a rotary member with a plurality of settings 109.1, representing, e.g., “filter only”; 109.2, representing, e.g., “nutrient only”; and 109.3, representing, e.g. “flavor only”. A default setting, not shown, could enable selection of treatment of the water by all of filtering, nutrients and flavoring. By rotating the rotary member to a desired setting, a user could receive a corresponding output at either the outlet 103 for enhanced drinking water, or at the outlet 110 for filtered-only water. The switching mechanism could be implemented, for example, with an arrangement of selectable valves, chambers and conduits, and is not described in detail herein.

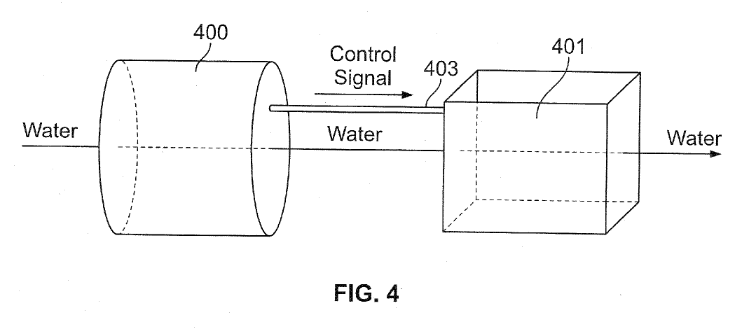

According to further embodiments, referring to FIG. 4, the dispensing mechanism could comprise a flow meter 400 coupled to a container 401 of a consumable enhancing additive. The flow meter and the container could be located in the enhancing portion, with the flow meter arranged so as to be able to measure a volume of water flowing through the enhancing portion. The flow meter could be electrically coupled to the container via a connection 403, and send a control signal through the connection to the container after measuring a predetermined volume of water. The control signal could cause the container to release a predetermined amount of a consumable enhancing additive into the flow of water through the enhancing portion.

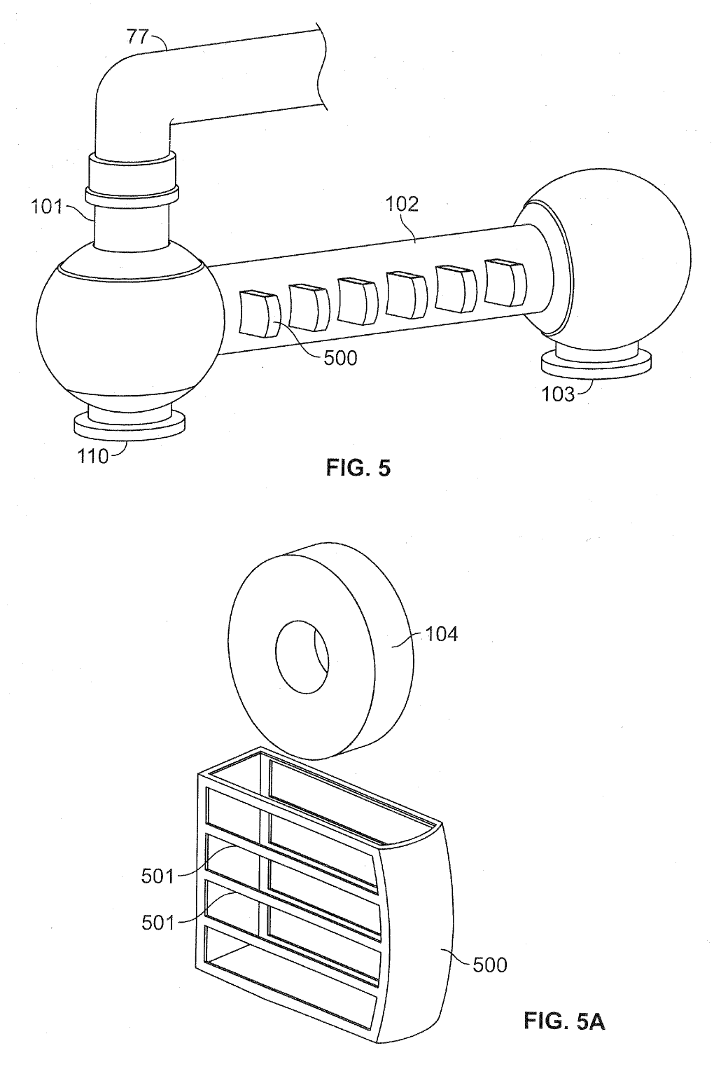

FIG. 5 illustrates another alternative embodiment. As shown in FIG. 5, the dispensing mechanism could comprise a plurality of refillable injectors 500 for holding consumable enhancing additives. The injectors, for example, could be formed as hollow buttons configured to be insertable into and retractable from a flow of drinking water through the enhancing portion 102. Thus, a user could select any desired combination of nutrients, vitamins, flavors, or other enhancing additives for treatment of the water, by filling the buttons with selected additives and inserting a corresponding combination of buttons into the water flow.

More specifically, as shown in FIG. 5A, the buttons 500 could be formed similarly to cabinet drawers, but with side walls constructed so as to allow water in the enhancing portion to flow through the walls. For example, the side walls might only comprise retaining members 501 for retaining a container of a consumable enhancing additives within the button 500, but otherwise be open to allow water to flow through. The buttons could be configured, for example, to receive and retain a cylindrical replaceable cartridge 104 as described earlier in connection with FIG. 2.

Examples of consumable enhancing additives that could be used with the foregoing system include, as noted earlier, vitamins, minerals and flavors, but could further include (but are not limited to) botanicals, herbals, dietary supplements, nutritional supplements, pharmaceuticals, carbonation and dyes. Various additives could be individually introduced in selected combinations as described above, or could be pre-combined in a single package.

As noted earlier, the additives could be encapsulated within tiny pills on the order of microns in size. An advantage of encapsulating the additives is that it provides some control over the timing and rate of the delivery of the additives into a volume of water. More specifically, different additives will typically have different solubility properties; solubility properties are further dependent on solvent flow rate and temperature. By coating an additive with a shell with known, consistent solubility properties, the timing and rate of delivery of the additive can be controlled to an extent. The system could also include a flow regulator for controlling the volume and rate of water admitted into the enhancing portion, for better control of additive delivery.

According to embodiments, the pill coating could have a range of solubility properties. For example, the pill coating could have a solubility that was dependent on the pH level of the medium in which it was suspended. In such an embodiment, the coating could be insoluble in water that is relatively pH balanced (e.g., pH=7), but soluble once in a person's stomach, where the pH is very acidic and in a healthy person is typically between 1 and 2, or more than ten thousand times as acidic as drinking water. Yet another alternative could involve using bicarbonate to mix with the additives, to control the rate and timing of delivery.

However, the foregoing are not the only methods of delivery of additives contemplated according to the present invention, and the additives need not be encapsulated in a pill as described, nor in a cartridge. For example, the additives could be in liquid form, powdered form, or solid form, similar to a bouillon cube. The additives could be in any kind of porous package, similar to a teabag.

According to embodiments, the system might further comprise a display window to display information relating to the system, such as the current contents of the additive containers of the system, how long the containers have been in use, nutritional information, and the like The display window could utilize LCD technology, for example, and be controlled by a programmable microchip.

Embodiments of the present invention are not limited to use with faucets or the like. For example, elements of the present invention could be adapted for use with portable containers such as pitchers, water bottles, or with other drinking water delivery systems such as water coolers or refrigerators. More specifically, an attachment for a container such as a pitcher or water bottle could be designed to include a filter and a replaceable dispenser of a consumable enhancing additive. Un-enhanced water could be introduced into, or dispensed from, the container via the attachment, thereby treating the water to enhance it. Similarly, elements of the present invention could be installed into a water cooler or refrigerator, and operated by corresponding buttons, switches and the like to selectively treat the water with enhancing additives.

Several embodiments of the present invention are specifically illustrated and/or described herein. However, it will be appreciated that modifications and variations of the present invention are covered by the above teachings and within the purview of the appended claims without departing from the spirit and intended scope of the invention.

1-23. (canceled)

24. A system for enhancing a content of non-carbonated drinking water, comprising:
an inlet connectable to a non-carbonated drinking water source;
an outlet;
a flow path defined in fluid communication between the inlet and the outlet;
a filter;
a drinking-water-enhancing portion disposed in the flow path between the inlet and the outlet such that the drinking water-enhancing portion is downstream and spaced apart from the filter,
the drinking-water-enhancing portion being configured to cooperate with a dispensing mechanism for dispensing a consumable enhancing additive into the flow path, wherein the dispensing mechanism comprises at least one container configured to releasably hold the consumable enhancing additive, the dispensing mechanism is operative to dispense the consumable enhancing additive into the flow path when the non-carbonated water is flowing from the inlet to the outlet; and
wherein the non-carbonated drinking water in the system is driven solely by a force selected from the group consisting of gravity and pressure from a source water line.

25. The system of claim 24, wherein the dispensing mechanism is formed as a replaceable cartridge containing the consumable enhancing additive.

26. The system of claim 24, further comprising a cartridge containing the consumable enhancing additive.

27. The system of claim 26, wherein the consumable enhancing additive includes a nutrient.

28. The system of claim 26, wherein the consumable enhancing additive includes a vitamin.

29. The system of claim 26, wherein the consumable enhancing additive includes a flavor.

30. The system of claim 25, wherein the drinking-water-enhancing portion comprises at least one sealable opening for receiving the replaceable cartridge.

31. The system of claim 25, wherein the replaceable cartridge is formed as a cylinder, the cylinder having walls connecting an inlet end and an outlet end, the walls having a plurality of openings therethrough for allowing the consumable enhancing additive contained within the cylinder to be released into the flow of drinking water, wherein a channel for the passage of drinking water through the cylinder extends between the inlet end and the outlet end.

32. The system of claim 31, wherein the channel has a spiral structure formed thereon.

33. The system of claim 24, wherein the dispensing mechanism comprises a plurality of refillable injectors for containing the consumable enhancing additive, the injectors being insertable into and retractable from the flow of drinking water.

34. The system of claim 33, wherein the refillable injectors are configured to hold a replaceable cartridge containing the consumable enhancing additive.

35. The system of claim 34, wherein the replaceable cartridge is formed as a cylinder, the cylinder having walls connecting an inlet end and an outlet end, the walls having a plurality of openings therethrough for allowing the consumable enhancing additive contained within the cylinder to be released into the flow of drinking water, wherein a hollow channel for the passage of drinking water through the cylinder extends between the inlet end and the outlet end.

36. The system of claim 24, wherein the dispensing mechanism comprises a flow meter coupled to the at least one container.

37. The system of claim 36, wherein the flow meter is configured to measure a volume of water passing between the inlet and the outlet, and to cause a predetermined amount of the consumable enhancing additive in the at least one container to be released in accordance with the volume measured.

38. The system of claim 25, further comprising an indicator associated with a monitoring mechanism for determining when the cartridge should be replaced.

39. The system of claim 24, wherein the dispensing mechanism comprises a first container and a second container, the system further comprising a switching mechanism configured to cause the flow of water to selectably be treated only by the filter, only by the dispensing mechanism, or by both the filter and the dispensing mechanism.

40. The system of claim 39, wherein the switching mechanism is further configured to cause the flow of water to selectably be treated by the dispensing mechanism to only receive a consumable enhancing additive from the first container, only receive a consumable enhancing additive from the second container, or to receive a consumable enhancing additive from both the first container and the second container.

41. The system of claim 24, wherein the consumable enhancing additive is enclosed within a pill coating.

42. The system of claim 24, wherein the additive is a liquid.

43. The system of claim 24, wherein the additive is a solid.

44. A method for enhancing a content of non-carbonated drinking water comprising:
a) drawing said non-carbonated drinking water from a source into an inlet;
b) passing said non-carbonated drinking water through a filter to form a filtered non-carbonated drinking water;
c) passing said filtered non-carbonated drinking water through a drinking-water-enhancing portion to form an enhanced non-carbonated drinking water wherein:
(i) the drinking-water enhancing-portion is downstream and spaced apart from the filter;
(ii) the drinking-water-enhancing portion further comprising a dispensing mechanism which comprises at least one container configured to releasably hold a consumable enhancing additive and said dispensing mechanism dispenses the enhancing additive into the filtered non-carbonated drinking water which flows from the filter to the outlet, thereby forming an enhanced non-carbonated drinking water; and
d) passing said enhanced non-carbonated drinking water through an outlet.
